(19) United States
(12) Patent Application Publication
(10) Pub. No.: US 2022/0232303 A1
(43) Pub. Date: Jul. 21, 2022

(54) BLUETOOTH HEADSET SPEAKER

(71) Applicant: DONGGUAN WANTAI ELECTRONICS TECHNOLOGY CO., LTD., Dongguan (CN)

(72) Inventors: Congdong Sha, Dongguan (CN); Zhigang Wang, Dongguan (CN); Shichun Zhao, Dongguan (CN); Yuanyuan She, Dongguan (CN); Feng Zhang, Donggukan (CN)

(21) Appl. No.: 17/151,844

(22) Filed: Jan. 19, 2021

(51) Int. Cl. H04R 1/02; H04R 1/10

(52) U.S. Cl. CPC H04R 1/023; H04R 2420/07; H04R 1/1008; H04R 1/1066

(57) ABSTRACT

The present invention provides a Bluetooth headset speaker, comprising a bracket, a diaphragm, a voice coil, a washer, a magnet, a U cup, a pad, a first tuning cloth, and a second tuning cloth, wherein the first tuning cloth is fixedly connected to the one side outer wall of the bracket, the one side outer wall of the bracket corresponding to the first tuning cloth is symmetrically provided with through grooves, a through hole is opened on the one side outer wall of the bracket, the second tuning cloth is fixedly connected to one side outer wall of the through hole. Compared with the existing headset speakers, the pad designed by the present invention is internally welded and does not need to be covered with glue, which not only can effectively reduce the production process, but also improves the simplicity of the appearance of the speaker and improves the integration degree of the overall structure of the speaker. The speakers designed by the present invention are noise-reducing, through the effect of noise-reducing structure and tuning cloth, the noise in the sound is filtered out, the distortion of the sound is reduced, and the sound quality of the speaker is improved.

### FIELD OF THE INVENTION

The present invention relates to the technical field of Bluetooth headset speakers, specifically relates to a Bluetooth headset speaker.

### BACKGROUND OF THE INVENTION

The speaker is a core device of the Bluetooth headset. It converts electrical signals into sound. However, the lead wires of the existing earphone speakers must be welded along the outside of the structure, and they need to be covered with glue. It is easy to cause poor speaker function and appearance due to insufficient lead wire coverage. The existing speaker has poor noise-reducing function, cannot filter noise well, and lacks necessary noise-reducing structure.

### OBJECTIVE OF THE INVENTION

The object of the present invention is to provide a Bluetooth headset speaker to solve the problems raised in the background art.

### SUMMARY OF THE INVENTION

In order to solve the above-mentioned technical problems, the present invention provides the following technical solutions: a Bluetooth headset speaker, comprising a bracket, a diaphragm, a voice coil, a washer, a magnet, a U cup, a pad, a first tuning cloth, and a second tuning cloth, wherein the diaphragm is fixedly connected to one side outer wall of the bracket, the voice coil is fixedly connected to one side outer wall of the diaphragm, and the voice coil is sleeved on one side inner wall of the bracket, the U cup is sleeved on the one side inner wall of the bracket, the magnet is sleeved on one side inner wall of the U cup, the washer is fixedly connected to one side outer wall of the magnet.

Further, card slots are symmetrically opened on the one side outer wall of the bracket, the pad is fixedly connected to one side inner wall of the card slots.

Further, the first tuning cloth is fixedly connected to the one side outer wall of the bracket, the one side outer wall of the bracket corresponding to the first tuning cloth is symmetrically provided with through grooves, a through hole is opened on the one side outer wall of the bracket, the second tuning cloth is fixedly connected to one side outer wall of the through hole.

Further, clamp blocks are distributed and fixed on the one side inner wall of the bracket, gaps are distributed on one side outer wall of the U CUP, the clamping blocks are sleeved on one side inner wall of the gaps.

Further, a shape of the first tuning cloth is “C” shape, and a shape of the second tuning cloth is circular.

Compared with the prior art, the beneficial effect achieved by the present invention is: compared with the existing headset speaker, the pad designed by the present invention is internally welded and does not need to be covered with glue, which not only can effectively reduce the production process, but also improves the simplicity of the appearance of the speaker and improves the integration degree of the overall structure of the speaker. The speakers designed by the present invention are noise-reducing, through the effect of noise-reducing structure and tuning cloth, the noise in the sound is filtered out, the distortion of the sound is reduced, and the sound quality of the speaker is improved.

### BRIEF DESCRIPTIONS OF THE DRAWINGS

The drawings are used to provide a further understanding of the present invention, and constitute a part of the specification. Together with the embodiments of the present invention, they are used to explain the present invention, and do not constitute a limitation to the invention.

FIG. 1 is a schematic diagram of the overall three-dimensional structure of the present invention; and

FIG. 2 is a schematic diagram of side view structure of the present invention.

Reference numbers in drawings are as follows in sequence:

In the drawings, 1 is a bracket, 2 is a diaphragm, 3 is a voice coil, 4 is a washer, 5 is a magnet, 6 is a U CUP, 7 is a pad, 8 is a first tuning cloth, and 9 is a second tuning cloth.

### DETAILED DESCRIPTION OF THE ILLUSTRATED EMBODIMENT

The technical solutions in the embodiments of the present invention will be clearly and completely described below in conjunction with the drawings in the embodiments of the present invention. Obviously, the described embodiments are only a part of the embodiments of the present invention, rather than all the embodiments. Based on the embodiments in the present invention, all other embodiments obtained by those of ordinary skill in the art without creative work all will fall within the scope of protection of the present invention.

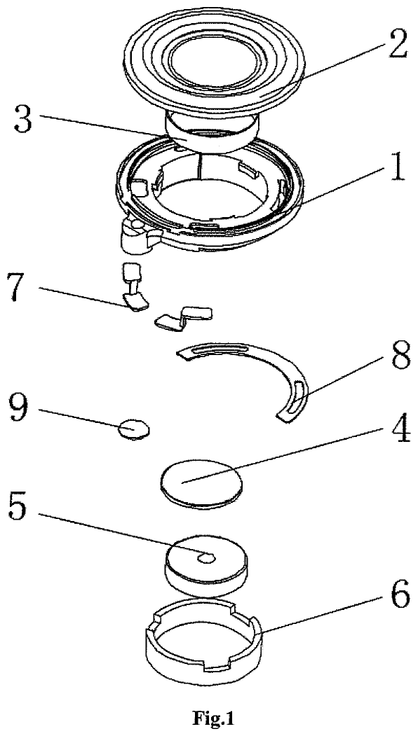

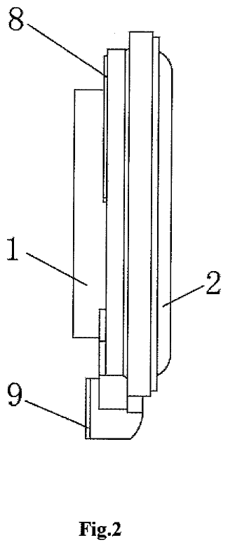

As shown in FIGS. 1 and 2, the present invention provides a technical solution: a Bluetooth headset speaker, comprising a bracket 1, a diaphragm 2, a voice coil 3, a washer 4, a magnet 5, a U cup 6, a pad 7, a first tuning cloth 8, and a second tuning cloth 9, wherein the diaphragm 2 is fixedly connected to one side outer wall of the bracket 1, the voice coil 3 is fixedly connected to one side outer wall of the diaphragm 2, and the voice coil 3 is sleeved on one side inner wall of the bracket 1, the U cup 6 is sleeved on the one side inner wall of the bracket 1, the magnet 5 is sleeved on one side inner wall of the U cup 6, the washer 4 is fixedly connected to one side outer wall of the magnet 5. Card slots are symmetrically opened on the one side outer wall of the bracket 1; the pad 7 is fixedly connected to one side inner wall of the card slots, which is used for welding lines. The first tuning cloth 8 is fixedly connected to the one side outer wall of the bracket 1, the one side outer wall of the bracket 1 corresponding to the first tuning cloth 8 is symmetrically provided with through grooves, a through hole is opened on the one side outer wall of the bracket 1, the second tuning cloth 9 is fixedly connected to one side outer wall of the through hole, the first tuning cloth 8 and the second tuning cloth 9 are used for dust prevention and noise filtering. Clamp blocks are distributed and fixed on the one side inner wall of the bracket 1, gaps are distributed on one side outer wall of the U cup 6, the clamping blocks are sleeved on one side inner wall of the gaps, the U cup 6 is used to form the internal magnetic type magnetic circuit system of the speaker while preventing external magnetism. A shape of the first tuning cloth 8 is “C” shape; a shape of the second tuning cloth 9 is circular.

It occupies a small space and is suitable for the inside of the headset, when assembling the present invention, first install the pad 7 to the bracket 1, fix the voice coil 3 on the diaphragm 2, then fix the diaphragm 2 on the bracket 1, and fix the wire of the voice coil 3 on the pad 7, then fix the washer 4 on the magnet 5, install the magnet 5 into the U cup 6, and then install the U cup 6 on the bracket 1, finally fix the first tuning cloth 8 and the second tuning cloth 9 on the bracket 1 to complete the assembly.

It should be noted that in this specification, relational terms such as “first” and “second” are only used to distinguish one entity or operation from another entity or operation, and do not necessarily require or imply any such actual relationship or order between these entities or operations. Moreover, the terms “comprising”, “including” or any other variations thereof are intended to cover non-exclusive inclusion, so that a process, method, article or device including a series of elements not only includes those elements, but also includes other elements that are not explicitly listed, or also includes elements inherent to such a process, method, article, or device.

Finally, it should be noted that the above is only preferred embodiments of the present invention, and is not used to limit the present invention, although the present invention is described in detail with reference to the foregoing embodiments, for those skilled in the art, they can still modify the technical solutions described in the foregoing embodiments, or equivalently replace some of the technical features. All modifications, equivalent replacements, improvements, etc. made within the spirit and principles of the present invention shall be included in the scope of protection of the present invention.

What is claimed is:

1. A Bluetooth headset speaker, comprising a bracket (1), a diaphragm (2), a voice coil (3), a washer (4), a magnet (5), a U cup (6), a pad (7), a first tuning cloth (8), and a second tuning cloth (9), wherein:
the diaphragm (2) is fixedly connected to one side outer wall of the bracket (1);
the voice coil (3) is fixedly connected to one side outer wall of the diaphragm (2), and the voice coil (3) is sleeved on one side inner wall of the bracket (1);
the U cup (6) is sleeved on the one side inner wall of the bracket (1);
the magnet (5) is sleeved on one side inner wall of the U cup (6); and
the washer (4) is fixedly connected to one side outer wall of the magnet (5).

2. The Bluetooth headset speaker according to claim 1, wherein:
card slots are symmetrically opened on the one side outer wall of the bracket (1); and
the pad (7) is fixedly connected to one side inner wall of the card slots.

3. The Bluetooth headset speaker according to claim 1, wherein:
the first tuning cloth (8) is fixedly connected to the one side outer wall of the bracket (1);
the one side outer wall of the bracket (1) corresponding to the first tuning cloth (8) is symmetrically provided with through grooves;
a through hole is opened on the one side outer wall of the bracket (1); and
the second tuning cloth (9) is fixedly connected to one side outer wall of the through hole.

4. The Bluetooth headset speaker according to claim 1, wherein:
clamp blocks are distributed and fixed on the one side inner wall of the bracket (1);
gaps are distributed on one side outer wall of the U cup (6); and
the clamping blocks are sleeved on one side inner wall of the gaps.

5. The Bluetooth headset speaker according to claim 1, wherein:
a shape of the first tuning cloth (8) is “C” shape; and
a shape of the second tuning cloth (9) is circular.
